(19) United States
(12) Patent Application Publication
(10) Pub. No.: US 2011/0086272 A1
(43) Pub. Date: Apr. 14, 2011

(54) LI-ION BATTERY AND ITS PREPARATION METHOD

(76) Inventors: Keith D. KEPLER, Belmont, CA (US); Hongjian Liu, Hercules, CA (US)

(21) Appl. No.: 12/904,109

(22) Filed: Oct. 13, 2010

Related U.S. Application Data
(60) Provisional application No. 61/278,943, filed on Oct. 13, 2009.

(51) Int. Cl. H01M 4/52; H01M 4/50; H01M 4/525; H01M 4/04

(52) U.S. Cl. 429/220; 429/223; 429/231.3; 429/224; 429/231.95; 29/623.1

(57) ABSTRACT

Disclosed herein is a Li-ion cell comprising a cathode, an anode, and a separator disposed between the cathode and the anode, wherein the cathode comprises Li-ion cathode active material, and the anode comprises Li-ion anode active material and an additive which has an energy density greater than that of the Li-ion anode active material and which is capable of reacting irreversibly with Li-ions.

### CROSS-REFERENCE TO RELATED APPLICATIONS

The present non-provisional application claims the benefits of the provisional application Ser. No. U.S. 61/278,943 filed on Oct. 13, 2009 which is incorporated by reference herein in its entirety.

### BACKGROUND

Some promising new cathode materials have the potential to provide greater capacity and a higher average voltage of operation than current commercial cathode materials used in Li-ion cells. These materials include for example the family of layered lithium containing oxides of the general formula Li₁₊ₓ(NiCoMn)O₂ (0<x<1) or spinel type lithium containing oxides such as Li₍₁₊ₓ₎(MnNi)₂O₄ (0<x<1). For example, one class of lithium-rich, manganese containing layered compounds has been found to provide stable reversible capacity up to 250-290 mAh/g when cycled to 4.6 V vs. lithium metal. These materials can be represented by the formula xLi₂MnO₃.(1−x)LiMO₂ (0<x<1) and described as layered/layered composite structures with a shared oxygen lattice, as proposed by Dr. Thackeray and his group at ANL. Unfortunately, many cathode materials including these high voltage cathode materials have an inherently large irreversible capacity loss during the first cycle that is thought to be associated with oxygen loss from the Li₂MnO₃ phase as it transforms to a layered MnO₂ phase that reversible intercalates Lithium ions. Furthermore, in some applications it is not desirable to cycle the cell to such high voltages. If the cell voltage is limited to 4.2 V after the initial formation cycle, then the reversible capacity of the material is lower, (˜200-220 mAh/g) but still very desirable. However, since this material must first be charged to release all of the lithium to become active, the effective irreversible capacity loss from the cathode can exceed 30%. This inherent irreversible capacity loss must be compensated by the anode in a full cell design to prevent lithium metal deposition which is a safety hazard and greatly reduces the cycle life of the cell, however, this approach will inevitably reduce the overall cell capacity.

### DRAWINGS

FIG. 1: Illustration of Voltage Curves for first charge and subsequent cycling for a cell of this invention.

### DETAILED DESCRIPTION

Therefore the present invention has been made in light of the above-mentioned problems. This invention provides a novel Li-ion cell which comprises a cathode, an anode, and a separator disposed between the cathode and the anode, wherein the anode comprising Li-ion anode active material and an additive which may have a volumetric or gravimetric energy density greater than that of the Li-ion anode active material and which may be capable of reacting irreversibly with Li-ions.

In a embodiment of the present invention, the amounts of the Li-ion cathode active material, the Li-ion anode active material and the additive may be selected such that at the first cycle of the cell, the reversible capacity of the Li-ion cathode electrode may be substantially equal to that of the Li-ion anode electrode, the irreversible capacity loss of the Li-ion cathode active material may be greater than that of the Li-ion anode active material, and the additive is capable of accommodating substantially all the excess irreversible capacity loss of the Li-ion cathode active material. The additive may have a greater gravimetric (mAh/g) or volumetric capacity (mAh/mL) than the anode active material, that is the additive is capable of taking up more lithium per volume or weight than the anode active material. The first cycle of the cell refers to the process of the first charging and the first discharging. The irreversible capacity loss of the Li-ion cathode active material refers to the difference between the charging capacity of the Li-ion cathode active material during the first charging and the discharging capacity of the Li-ion cathode active material during the first discharging. The irreversible capacity loss of the Li-ion anode active material refers to the difference between the charging capacity of the Li-ion anode active material during the first charging and the discharging capacity of the Li-ion anode active material during the first discharging. The term “the additive is capable of accommodating all the excess irreversible capacity loss of the Li-ion cathode active material” means that all the Li-ions generated from the cathode, associated with the excess irreversible capacity loss of the Li-ion cathode active material is reacted with the additive. The term “excess irreversible capacity loss” means any irreversible capacity loss of the cathode electrode in excess of the irreversible capacity loss of the anode electrode. According to the present invention, the additive is capable of reacting irreversibly with Li-ions, so that the Li-ions generated by the excess irreversible capacity loss of the Li-ion cathode active material is prevented from being deposited on the anode in the form of lithium metal. In addition, since the additive has an energy density greater than that of the Li-ion anode active material, there is a minimum penalty on the overall cell capacity.

In one aspect of this invention, the ratio of lithium ion active anode material to the additive in the anode is selected such that the reversible capacity of the anode electrode in the cell is less than 12% greater than the reversible capacity of the cathode electrode in the cell.

In one aspect of this invention, the additive is selected to react with lithium from the cathode to irreversibly form a lithium ion conductive material. In another aspect of this invention the additive is selected to react with lithium from the cathode to irreversibly form a lithium ion conductive material interspersed with an electronically conductive phase. In another aspect of this invention the additive is selected to react with lithium from the cathode to irreversibly form an electronically conductive composite material. In another aspect of this invention the additive is selected to react with lithium from the cathode to irreversibly form a material soluble in the electrolyte.

In one embodiment of this invention, the additive may be incorporated into the anode electrode of the Li-ion cell as a separate phase, physically mixed with the anode active material. In another embodiment of this invention, the additive may be incorporated into the anode electrode of the Li-ion cell as a coating on the anode active material and in another embodiment of this invention the additive may be incorporated into the anode electrode of the Li-ion cell as a composite phase with the anode active material.

In an embodiment of this invention the Li-ion cell comprises a layered lithium transition metal oxide cathode and a graphite anode as the reversible Li-ion active materials. In another embodiment of this invention the Li-ion cell comprises a layered lithium transition metal oxide cathode and a lithium titanate spinel phase anode as the reversible Li-ion active materials. In one aspect of this invention the additive is selected from the group of materials comprising Selenium, Phosphorus, iodine and polymeric (CFₓ)ₙ(0.9<x<1.2). In another aspect of this invention the additive is selected from electronically conductive forms of these materials including grey selenium, black phosphorus and iodine/P2VP composite. In another aspect of this invention the additive is selected from the group comprising an intermetallic compound containing an element selected from the following group, selenium, phosphorus, and iodine. The intermetallic compound may contain at least one of Cu, Ni and Co. In another aspect of this invention the additive is selected from the group comprising metal oxides, wherein the metal does not form an alloy with lithium such as at least one of Cu, Ni and Co. In an embodiment of this invention the additive is reduced in reactions with lithium at a voltage greater than that of the active Li-ion anode phase. In an embodiment of this invention the tap density of the additive is greater than 1.3 times the tap density of the anode active material. In an embodiment of this invention, the additive is electronically conductive.

Although the lithiated phase formed from the additive may be reversible at a certain high voltage, the anode voltage is maintained below that voltage during normal operation of the cell.

The Li-ion cathode active material may be any material suitable to be used in the Li-ion cell, whose examples include but are not limited to layered lithium containing oxides of the general formula Li₁₊ₓ(NiCoMn)O₂ (0<x<1) and/or spinel type lithium containing oxides such as Li₍₁₊ₓ₎(MnNi)₂O₄ (0<x<1). The Li-ion anode active material may be any material suitable to be used in the Li-ion cell, whose examples include but are not limited to graphite and/or Li₄Ti₅O₁₂.

The present invention provides a Li-ion cell with high energy density and high power capability. In lithium ion cells the anode electrode capacity for accommodating lithium from the cathode is designed to be greater than the total amount of lithium that is removed from the cathode when the cell is charged. The capacity of each electrode is considered to be the total of both the reversible capacity of the electrode and the initial irreversible capacity associated with the electrode. For cathode materials the irreversible capacity loss is often associated with subtle phase changes or relaxation of the material structure as the lithium is removed for the first time that prevent 100% of the lithium from being reinserted into the active material structure when the cell is subsequently discharged. Typical irreversible capacity losses associated with the cathode active material range from 5% to 8%. At the anode side the irreversible capacity loss can be associated with similar mechanisms, but is often dominated by the formation of an initial surface layer of electrolyte decomposition products on the anode material that consumes some lithium from the cathode. The irreversible loss of lithium from these anode reactions is also typically in the range of 5%-8%. In a typical cell the total anode electrode capacity is designed to be 3%-6% greater than that of the cathode electrode. This standard design prevents the deposition of lithium metal at the anode which is highly detrimental to the cycle life of the Li-ion cell and can lead to unsafe conditions. However, the closer the total capacity of the anode and cathode electrodes are matched then the greater the cell capacity can be, since any excess anode electrode takes up space that could be used to add more cathode material to the cell. Thus when designing a Li-ion cell, the designer is trading off the cell capacity against the performance and safety of the cell using the cathode to anode capacity ratio. It is thus highly desirable to be able to minimize the total volume that the anode occupies in the cell without sacrificing performance or safety so that more cathode material can be fit into the cell.

Often in a Li-ion cell the irreversible capacity associated with the cathode and the irreversible capacity associated with the anode are similar. The cell design is such that a cathode with an irreversible capacity (>5%) loss can be accommodated efficiently at the anode with a minimal sacrifice in the cell capacity. In some cases the irreversible capacity of the cathode can be quite large (>˜8%). Typically this irreversible loss is accommodated in the anode by adding more anode active material, some of which is not fully utilized because it acts only as storage for the excess irreversible capacity from the cathode. If the anode active material has a low specific density or low tap density then the extra space taken up at the anode to accommodate the irreversible capacity from the cathode can be significant and lead to major limitations on the total capacity of the cell. In the present invention, this problem may be solved by incorporating the additive in the anode that has a high density and a high gravimetric or volumetric energy density that can irreversibly react with the excess lithium from the cathode. By replacing the low density active material in the anode with a high energy density lithium scavenger the overall cell capacity can be increased significantly. Furthermore the cell performance can benefit from the formation of beneficial phases in the anode during the reaction of the lithium with the second phase.

The Li-ion cell may be prepared by providing and assembling a cathode, an anode, and a separator, wherein the cathode comprises Li-ion cathode active material, and the anode comprises Li-ion anode active material and an additive which may have a tap density greater than that of the Li-ion anode active material and which may be capable of reacting irreversibly with Li-ion.

The cathode may be prepared by the conventional method used in this art, for example, forming the cathode active material into a slurry by using a solvent and adhesive, coating the slurry on a substrate for cathode, and drying. The anode may be prepared by the conventional method used in this art, for example, forming the anode active material into a slurry by using a solvent and adhesive, coating the slurry on a substrate for anode, and drying. The method for assembling may be the conventional method used in this art, for example, disposing the separator between the anode and the cathode, winding into an electrode core, placing the electrode core into a case, and immersing the electrode core with the electrolyte solution.

### BEST MODE

### Example 1

An example of a cell of this invention could include a cell in which the cathode comprises a layered xLi₂MnO₃.(1−x)LiMO₂ (0<x<1, and M represents Ni, Co or Mn) phase with a first charge capacity of ˜310 mAh/g and a first discharge and reversible capacity of ˜250 mAh/g corresponding to a ˜20% irreversible loss in capacity that must be accommodated at the anode. In this example, the anode active material is Li₄Ti₅O₁₂, which has a specific density ˜3.2 g/cc and a tap density of less than 1.5 g/cc and an irreversible capacity loss of ˜3%. To design a well balanced cell the remaining 17% irreversible capacity of the cathode needs to be accommodated in the anode. In the cell of this invention a second material is incorporated into the anode electrode that has a higher energy density than the anode active material, in this case Li₄Ti₅O₁₂. For example, CuO with a density of 6.5 g/cc and a theoretical capacity of 673 mAh/g can be added to the anode. The CuO irreversibly accommodates excess Lithium when the cell is first charged through the formation of Li₂O and Cu metal. Furthermore, the Cu metal formed can increase the power capability of the anode by decreasing the electronic resistance of the electrode. The ratio of Li₄Ti₅O₁₂ to CuO in the anode is chosen such that the reversible capacity of the cathode is balanced by the low density reversible Li₄Ti₅O₁₂ anode active phase, while the irreversible capacity of the cathode is balanced by the irreversible high density CuO phase. Cell design calculations indicate that the anode thickness can be decreased by 10% or more vs a cell with an anode not containing CuO, while maintaining the same cathode to anode capacity ratio, same reversible capacity and same electrode porosity. The conserved space allows for the addition of more electrode material to increase the capacity of the cell by more than 9%.

Another example of a cell of this invention could include a cell as described above with the exception that instead of using CuO in the anode a Se intermetallic phase is used such as CuSe to form copper metal and the lithium ion conductive phase Li₂Se. While Se itself can be used, the intermetallic form both aids in the utilization of the Se to form Li₂Se and provides a highly electron conductive matrix from the reduced Cu metal. Furthermore, Li₂Se is stable up to 2 V vs Lithium which is above the normal operating voltage of a Li₄Ti₅O₁₂ electrode. Fully utilized CuSe has a irreversible capacity of 374 mAh/g and a tap density nearly 3 times that of the Li₄Ti₅O₁₂ active material. In a cell designed using CuSe as the additive in the anode with a Li₄Ti₅O₁₂ active material the thickness of the anode can be reduced by more than 5% while retaining the same first charge capacity. The extra space available allows the cell to be redesigned to increase the capacity by adding more cathode. As in the example above, the ratio of CuSe to the anode active phase is selected to maximize the volumetric energy density of the anode while maximizing the reversible capacity of the anode. The cell capacity can be increased by more than 5% for the same volume cell.

Other examples of pairings of the anode with high energy density additives of this invention are listed below in the table. Estimates of the increase in anode electrode density were calculated by assuming a fixed cathode electrode wherein the first charge cycle to 4.6 V is 310 mAh/g and the reversible capacity of the cathode active material is 220 mAh/g when the cell is limited to a cathode electrode voltage of 4.2 V. This represents an irreversible capacity loss for the cathode electrode of approximately 30%. The energy density of the anodes of the examples in the Table below were calculated assuming the anode electrode must meet these conditions.
a. The capacity per area of the anode is fixed to match the cathode capacity per area.
b. The porosity of the anode is fixed at 30%.

Using these assumptions the additive to active mass ratios are optimized to compensate for the irreversible loss associated with the cathode. The energy density of the electrode is calculated from the reversible capacity of the anode electrode per unit area, adjusted for any loss associated with the cathode, and the thickness of the electrode to achieve a 30% porosity. The final column shows the percent increase in anode energy density for this cell design over the baseline.

| | Active | | Additive | | Optmized Anode for Fixed Cathode | | |
|---|---|---|---|---|---|---|---|
| | Energy | | Approx. Energy | Approx. | | Optimized Anode | |
| | Density | Density | Density | Density | Additive/Active | Electrode Energy Density | |
| Anode | mAh/g | g/cm3 | mAh/g | g/cm2 | % Mass/% Mass | mAh/cm3 | over Baseline |
| Baseline LI4Ti5O12 | 160 | 3.5 | NA | NA | 0 | 250 | NA |
| Baseline Graphite | 350 | 2 | NA | NA | 0 | 330 | NA |
| Li4Ti5O12 + CuO | 160 | 3.5 | 600 | 6 | 0.096 | 320 | 22% |
| Li4Ti5O12 + I(P2VP) | 160 | 3.5 | 200 | 4 | 0.3 | 280 | 11% |
| Li4Ti5O12 + (CFx)n | 160 | 3.5 | 850 | 2 | 0.07 | 310 | 19% |
| Li4Ti5O12 + Se | 160 | 3.5 | 650 | 4 | 0.096 | 320 | 22% |
| Li4Ti5O12 + CuSe2 | 160 | 3.5 | 450 | 4 | 0.15 | 300 | 17% |
| Graphite + P | 350 | 2 | 2000 | 2 | 0.064 | 420 | 21% |
| Graphite + P-X | 350 | 2 | 600 | 4 | 0.19 | 390 | 15% |
| Graphite + Se | 350 | 2 | 650 | 4 | 0.18 | 400 | 18% |
| Graphite + (CFx)n | 350 | 2 | 850 | 2 | 0.15 | 390 | 15% |

Some specific examples may include a Li₄Ti₅O₁₂ anode material coated with a layer of copper oxide or copper selenide to both increase electronic conductivity and to provide a method for trapping excess lithium from the cathode after the first charge when the copper oxide or copper selenide is reduced to form Cu metal and lithium oxide or lithium selenide.

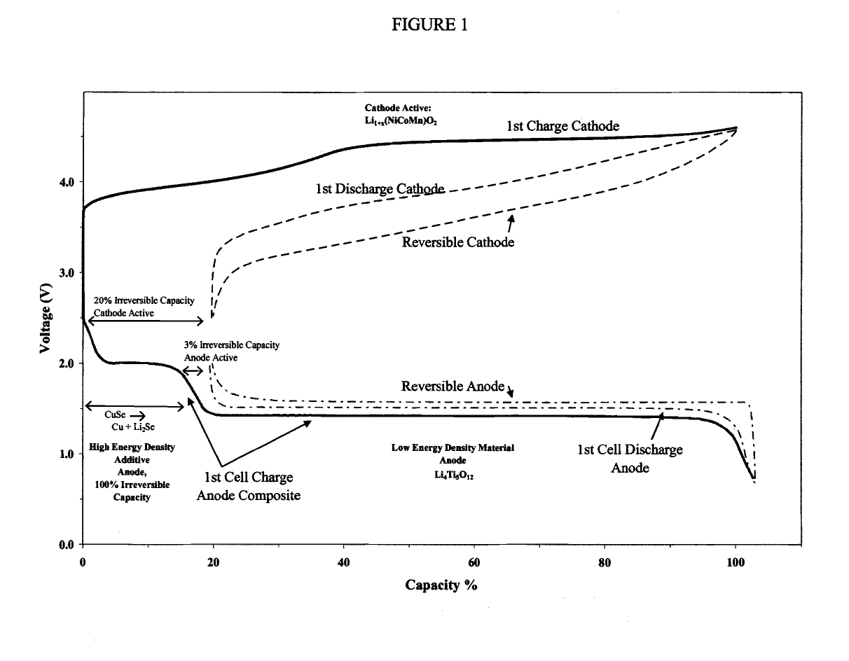

FIG. 1 shows an illustration of the voltage curve for the first cycle and subsequent cycles of one example of a cell of this invention. In this illustration, the cell is designed such that there is no lithium metal deposition (the anode never reaches 0V). In this particular example, the cell is designed to be cathode limited during cycling after the initial cycle (as shown by the dotted lines). Specifically the cell illustrated uses a lithium rich Li₁₊ₓ(NiCoMn)O₂ cathode with a large 20% irreversible loss between the first charge and first discharge (shown as a solid line). The anode comprises a low density Li₄Ti₅O₁₂ material (such as nanophase Li₄Ti₅O₁₂) mixed with enough higher density CuSe material to consume the irreversible lithium from the cathode during a reaction that occurs at ˜2.0V on the first cell charge to form Cu metal and Li₂Se. The cathode irreversible loss is thus balanced by an irreversible loss associated with the formation of Li₂Se, Cu metal, and with the inherent loss associated with the Li₄Ti₅O₁₂ material. Because of the high density of the CuSe phase, less volume is required to compensate for the first cycle cathode irreversible loss than would be required if the Li₄Ti₅O₁₂ material was used to compensate it alone. Because the reduction/oxidation potential of the additive material (CuSe) is greater than the active material it remains inactive during normal cell operation.

1. A Li-ion cell comprising a cathode, an anode, and a separator disposed between the cathode and the anode, wherein the cathode comprises Li-ion cathode active material, and the anode comprises Li-ion anode active material and an additive which has an energy density greater than that of the Li-ion anode active material and which is capable of reacting irreversibly with Li-ions.

2. The Li-ion cell according to claim 1, wherein the amounts of the Li-ion cathode active material, the Li-ion anode active material and the additive are selected such that at the first cycle of the cell, the reversible capacity of the Li-ion cathode electrode is substantially equal to that of the Li-ion anode electrode the irreversible capacity loss of the Li-ion cathode active material is greater than that of the Li-ion anode active material, and the additive is capable of accommodating all the excess irreversible capacity loss of the Li-ion cathode active material.

3. The Li-ion cell according to claim 1, wherein the additive is selected from the group consisting of selenium, phosphorus, polymeric CFₓ, and iodine.

4. The Li-ion cell according to claim 3, wherein the additive is selected from the group consisting of grey selenium, black phosphorus, and iodine/P2VP composite.

5. The Li-ion cell according to claim 1, wherein the additive is an intermetallic compound containing at least one element of selenium, phosphorus, and iodine in which the metal contained therein does not form an alloy with lithium.

6. The Li-ion cell according to claim 5, wherein the intermetallic compound contains at least one of Cu, Ni and Co.

7. The Li-ion cell according to claim 1, wherein the additive is a metal oxide in which the metal contained therein does not form an alloy with lithium.

8. The Li-ion cell according to claim 7, wherein the metal is at east one of Cu, Ni and Co.

9. The Li-ion cell according to claim 1, wherein the Li-ion cathode active material is at least one of layered lithium containing oxides of the general formula Li₁₊ₓ(NiCoMn)O₂ (0<x<1), spinel type lithium containing oxides such as Li₍₁₊ₓ₎(MnNi)₂O₄ (0<x<1) and the materials represented by the formula xLi₂MnO₃.(1−x)LiMO₂ (0<x<1, and M represent at least one of Ni, Co and Mn), and the Li-ion anode active material is graphite and/or Li₄Ti₅O₁₂.

10. A process for preparing a Li-ion cell comprising proving and assembling a cathode, an anode, and a separator, wherein the cathode comprises Li-ion cathode active material, and the anode comprises Li-ion anode active material and an additive which may have a energy density greater than that of the Li-ion anode active material and which may be capable of reacting irreversibly with Li-ion.

11. The process according to claim 10, wherein the amounts of the Li-ion cathode active material, the Li-ion anode active material and the additive are selected such that at the first cycle of the cell, the reversible capacity of the Li-ion cathode active material is substantially equal to that of the Li-ion anode active material, the irreversible capacity loss of the Li-ion cathode active material is greater than that of the Li-ion anode active material and the additive, and the additive is capable of accommodating all the remaining irreversible capacity loss of the Li-ion cathode active material.

12. The process according to claim 10, wherein the additive is selected from the group consisting of selenium, phosphorus, iodine and polymeric CFx.

13. The process according to claim 12, wherein the additive is selected from the group consisting of grey selenium, black phosphorus, and iodine/P2VP composite.

14. The process according to claim 10, wherein the additive is an intermetallic compound containing at least one element of selenium, phosphorus, and iodine.

15. The process according to claim 14, wherein the intermetallic compound contains at least one of Cu, Ni and Co.

16. The process according to claim 10, wherein the additive is a metal oxide in which the metal contained therein does not form an alloy with lithium.

17. The process according to claim 16, wherein the metal is at least one of Cu, Ni and Co.

18. The process according to claim 1, wherein the Li-ion cathode active material is at least one of layered lithium containing oxides of the general formula Li₁₊ₓ(NiCoMn)O₂(0<x<1), spinel type lithium containing oxides such as Li₍₁₊ₓ₎(MnNi)₂O₄ (0<x<1) and the materials represented by the formula xLi₂MnO₃.(1−x)LiMO₂ (0<x<1, and M represent at least one of Ni, Co and Mn), and the Li-ion anode active material is graphite and/or Li₄Ti₅O₁₂.
